(19) United States
(12) Patent Application Publication
(10) Pub. No.: US 2007/0047524 A1
(43) Pub. Date: Mar. 1, 2007

(54) PERIPHERAL DEVICE, INFORMATION PROCESSING DEVICE COMMUNICATING WITH PERIPHERAL DEVICE, AND METHOD REGARDING SETTINGS APPLICABLE TO INFORMATION PROCESSING DEVICE

(75) Inventor: Takashi Moriya, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Tokyo (JP)

(21) Appl. No.: 11/460,910

(22) Filed: Jul. 28, 2006

(30) Foreign Application Priority Data
Aug. 12, 2005 (JP) 2005-234619

(51) Int. Cl. H04L 12/66

(52) U.S. Cl. 370/352

(57) ABSTRACT

An information processing device is configured to set up a port as one of an output destination and an input destination corresponding to a peripheral device. The information processing device is configured to acquire identification information on the port from the peripheral device, and to determine whether identification information on the port is already set up in the peripheral device. The information processing device is configured to, when the determining unit determines that identification information on the port is not yet set up in the peripheral device, set up, in the peripheral device, identification information on the port corresponding to the peripheral device and setup, in the information processing device, the identification information on the port as a name of the port.

### BACKGROUND OF THE INVENTION

1. Field of the Invention

The present invention relates to a peripheral device, an information processing device communicating with the peripheral device, and a method regarding settings applicable to the information processing device, and a system including these devices.

2. Description of the Related Art

In recent years, a network enabled appliance using a wired local network (LAN) and a wireless LAN has come into wide use in various environments, including at home. Heretofore, with respect to a printer, it has been common to connect a printer to a personal computer (PC) on a one-for-one basis through a local interface such as USB (Universal Serial Bus) and the like. However, there has been an increasing demand for a network capable of meeting the needs of printing from a plurality of PCs by using a set of printer even at home.

Hence, in the environment where a plurality of PCs share and use one or more printers, a method of generating an output destination port name has been proposed. The output destination port name is used by a host computer (e.g., PC) when a printer is selected and a printing instruction is issued.

For example, as a procedure to print data created by a PC, first, a print command is transmitted to a network port associated with an installed printer driver from a higher-level application. Next, the port driver issues an instruction to a lower-level LAN driver for printing via a network.

With respect to the method of generating a port name, a method of extracting a model name from a device identifier (ID) and using this information to determine if peripheral devices currently connected are the same as the peripheral devices connected in the past is disclosed (Japanese Patent Application Laid-Open No. 2003-196224).

When a plurality of USB appliances are connected to a PC through a USB hub, port names are automatically set up. Thus, the port names maybe automatically generated using labels such as USB001, USB002, and USB003. One of the problems associated with such method is that the port name and an actual output destination printer are not always properly associated and as a result, the actual output destination printer may end up being unidentifiable. Hence, it has been proposed that identification of a peripheral device can be made possible by generating a port name based on extraction of a model name from a device ID and extraction of a serial ID from a link name.

In this manner, the difficulty associated with identifying which peripheral appliances are connected to a plurality of ports holds true with the network ports using wireless and wired LANs. In a case where there exist a plurality of network interfaces such as a wireless LAN interface and a wired LAN interface within a network setting, a method of re-confirming later as to which ports created are associated with which interfaces is indispensable not only in situations where multiple printers exist within the network but also in situations where only one printer exists within the network.

For example, in the case of Windows (registered trademark) operating system of Microsoft Corporation, when printer properties of a printer are opened, and a setup screen for a port is opened, and then, an “addition of new port” button is pressed, the types of ports useable as a printer port are displayed in a list. Included in the printer port list is a “standard TCP/IP port”. When this standard TCP/IP printer port is generated, an IP address (4 bytes) is often allotted to a part of the port name of the system as an identifier. Further, in the printer port taking a commonly used network printer as an output destination, there is also the case where a media access control (MAC) address (6 bytes) is allotted to the port name as an identifier. However, the IP address and the MAC address are not always inscribed on the visible position of the network devices, and it is often difficult to use such inscription as an identification method because of the necessity to compare numerical values or hexadecimal numbers.

Hence, in the network device, there is a method known, in which a device identification name is registered in the storage medium of the device itself, thereby allowing detection and display of the device through the network. For example, in the operating system of Windows (registered trademark) of Microsoft corporation, it is possible to assign a computer name to each PC. For example, if it is a notebook PC, it is possible to assign a name, such as, for example, “HOME-NOTEPC” to the notebook PC. In the network of Windows (registered trademark), when a higher-level application designates a communication partner, neither the IP address nor the MAC address is used. Instead, an intelligible “name” is used by using a NetBIOS interface. This name can be used as a default name or it can be intentionally changed by a user later on.

There is also a method of identifying a device by assigning a device identification name to a wireless device itself (Japanese Patent Application Laid-Open No. 2000-242454).

Further, with Bluetooth devices, in addition to using identification information such as the MAC address carried by a device itself, an identifying method may be employed which registers the device identification name in the device itself. This device address information and the device identification name can be referred to from each PC. However, this identification name has problems in that confusion can occur when a plurality of devices are unintentionally attached with the same names by different users. Dealing with the case where it is desired to set up a device with different names for each PC can be difficult if not impossible. Hence, as additional information, a local name is stored in the storage medium for each PC for the device, thereby allowing the device to be better identifiable. The MAC address, the device identification name, and the local name carried by the device are controlled by generating a device management table in each PC, so that identification is made as to what type of a device it is, how it is intended to be used, and the like.

A port name generated during installation of a network device into a PC is either automatically generated as a default name including identification information on individual devices such as the MAC address, the IP address, or the types of interfaces of the device, or manually generated by a user changing it explicitly into a port name easily recognizable by the user. However, in the setup of a printer targeted for a plurality of PCs, when the port name is desired to be commonly shared, the operation for that purpose becomes complicated.

For example, as shown in FIG. 1, presume that a computer 1 (1-1), a computer 2 (1-3), and a computer 3 (1-4) are set up such that they can communicate with one another via a local area network. (To simplify the description, the network used here is illustrated as a wired network using Ethernet (registered trademark), but a wireless network can be used). An installation procedure in a case where the foregoing setup is added with an unset network printer A (1-2) so that printing can be made from each PC is as follows.

For example, consider the case where communication setups are made from the computer 1 to the network printer A. Then, since the network printer A is detectable from the computer 1, the computer 2, and the computer 3 via the network, the network printer A is detected by each PC so that a printer driver and a port driver are installed in order, thereby allowing a port to be created. However, in a case where the user wants to share an intelligible port name with all of the PCs, it is necessary to manually change the port name at each installation in the computer 1, computer 2, and computer 3.

### SUMMARY OF THE INVENTION

One of the features of an embodiment of the present invention is to provide a method of reducing complicated operations such as repeating a change of the port name each time port configuration, allowing a printer to be usable, is set up for a plurality of computers.

According to an aspect of the present invention, an embodiment is directed to an information processing device configured to set up a port as one of an output destination and an input destination corresponding to a peripheral device. The information processing device includes an acquiring unit, a determining unit and a setup unit. The acquiring unit is configured to acquire identification information on the port from the peripheral device. The determining unit is configured to determine whether identification information on the port is already set up in the peripheral device. The setup unit is configured to, when the determining unit determines that identification information on the port is not yet set up in the peripheral device, set up, in the peripheral device, identification information on the port corresponding to the peripheral device and set up, in the information processing device, the identification information on the port as a name of the port.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention. It is noted that the references to “an” or “one” embodiment of this disclosure are not necessarily directed to the same embodiment, and such references mean at least one.

FIG. 1 is a diagram showing an exemplary system having a printing device coupled to a plurality of information processing devices to which embodiments of the present invention can be applied.

FIG. 2 is a block diagram showing a part of FIG. 1 of an information processing system according to an exemplary embodiment of the present invention.

FIG. 3 is a view showing an example of a device configuration when a wireless network is installed using a USB according to an embodiment of the present invention.

FIG. 4 is a view showing common screen captures displayed during installation of a printer driver using the USB.

FIG. 5 is a flowchart showing a common installation procedure of the printer driver using the USB.

FIG. 6 is a view showing an example of a screen capture associated with a standard setup database of an operating system (OS).

FIG. 7 is a view showing an example of a screen displaying a printer list in the OS.

FIG. 8 is a view showing exemplary screen captures displayed during a printer driver installation process according to an embodiment of the present invention.

FIG. 9 is a view showing exemplary screen captures displayed during a printer driver installation process according to an embodiment of the present invention.

FIG. 10 is a flowchart showing the printer driver installation process according to an embodiment of the present invention.

FIG. 11 is a flowchart showing the installation procedures of a printer and a PC according to an embodiment of the present invention.

FIG. 12 is a flowchart showing a network setup process for a printer according to an embodiment of the present invention.

FIG. 13 is a flowchart showing a printer driver installation process according to an embodiment of the present invention.

FIG. 14 is a flowchart showing a port creating process according to an embodiment of the present invention.

FIG. 15 is a flowchart showing a port creating process performed collectively according to an embodiment of the present invention.

FIG. 16 is a view showing exemplary screen captures associated with an installation procedure for a wireless network according to an embodiment of the present invention.

FIG. 17 is a view showing exemplary screen captures associated with an installation procedure for a wireless network according to an embodiment of the present invention.

FIG. 18 is a view showing exemplary screen captures associated with an installation procedure for a wireless network using a wireless LAN according to an embodiment of the present invention.

FIG. 19 is a view showing exemplary screen captures associated with an installation procedure according to an embodiment of the present invention.

FIG. 20 is a view showing exemplary screen captures associated with an installation procedure according to an embodiment of the present invention.

### DETAILED DESCRIPTION OF THE EMBODIMENTS

Exemplary embodiments of the invention will be described in detail below with reference to the drawings.

<System Configuration>

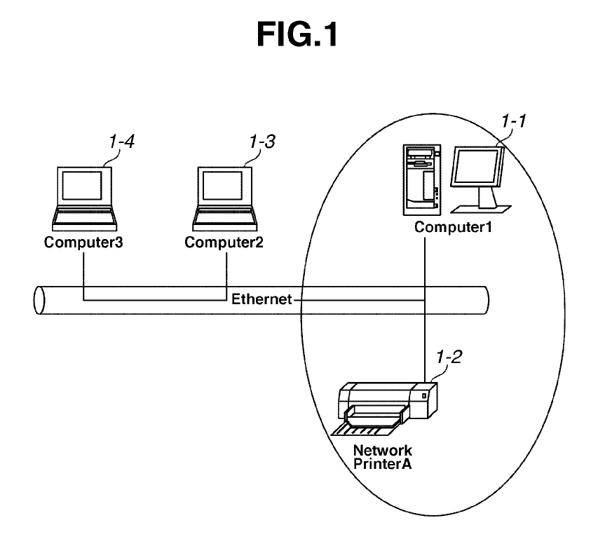

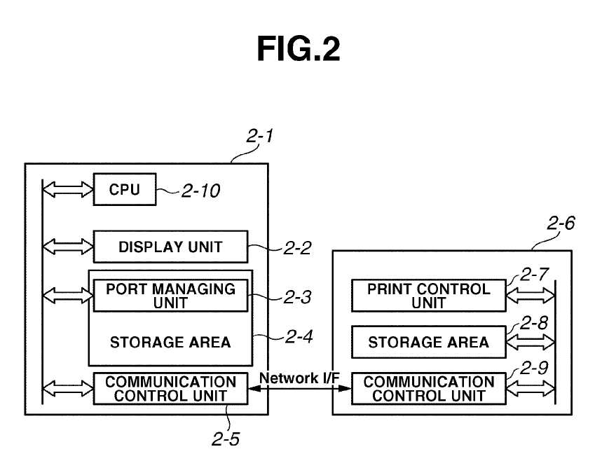

FIG. 2 is a block diagram showing a schematic configuration of an information processing system according to an exemplary embodiment of the present invention. An information processing device 2-1 (computer 1) and a printing device 2-6 (network printer A) can communicate with each other via a network through a communication interface. Incidentally, FIG. 2 is apart of a system shown in FIG. 1 taken out and enlarged. While FIG. 2 omits an illustration, in one embodiment, a network I/F corresponds to Ethernet (registered trademark) in FIG. 1, and in addition to the computer 1, computers 2 and 3, and the network printer A are configured to be able to communicate with one another. In one embodiment, the computers 1, 2, and 3 are configured by the same hardware.

The information processing device 2-1 (computer 1) may use a standard personal computer or a workstation as hardware. A port managing unit 2-3, which is a program stored in a storage area 2-4, is executed by a CPU 2-10. The port managing unit 2-3 manages a port name and address information on a printer of an output destination and the like in units of a port unit, and has a function to store them in the storage area 2-4. In one embodiment, the port managing unit 2-3 is configured as a part of a mother board, which is a hardware circuit. When a user performing a setup of the printing device 2-6 at first changes a port name, the port name is transmitted to a communication control unit 2-9 of the printing device 2-6 via a communication control unit 2-5 with the port name taken as a device identification name. The printing device 2-6 stores the received device identification name in a storage area 2-8. Subsequently, when a new user performs a setup of the printing device 2-6, the device identification name stored in the printing device 2-6 is read from the storage area 2-8, and is set up as a default port name. Further, a print control unit 2-7 has a function to read a device ID from the storage area 2-8 and send it to the communication control unit 2-5 of the information processing device 2-1 via the communication control unit 2-9. In one embodiment, the communication control units 2-5 and 2-9 include not only the network I/F, but also a USB communication function as described below (illustration omitted in FIG. 2).

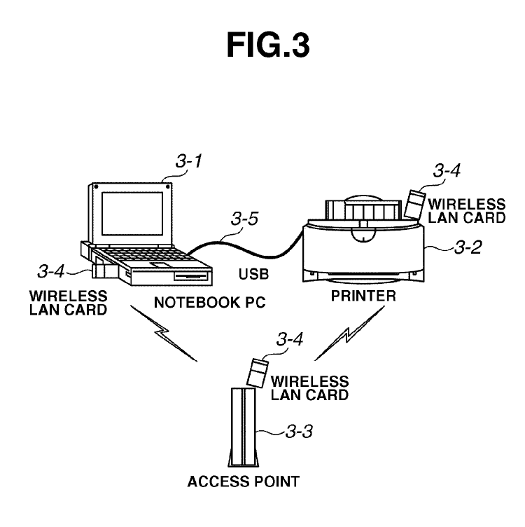

FIG. 3 shows an example of an information processing system having a wireless LAN interface according to an exemplary embodiment. First, for ease of explanation, a description will be made on the case where there is only one PC available.

A notebook PC 3-1 in FIG. 3 (which is the same device as the computer 1 or the information processing device 2-1) is configured to be able to use a USB cable 3-5 as a wired local interface and a wireless LAN card 3-4 of the PCMCIA card type as a wireless local interface. A printer 3-2, similarly to the PC 3-1, also includes both of the wired local interface and the wireless interface. The wired local interface is realized by connecting the PC 3-1 and the printer 3-2 (which is the same device as the network printer A and the printing device 2-6) by the USB cable 3-5. The wireless interface is realized by installing the wireless LAN card 3-4 of the PCMCIA type. An access point 3-3, which is an access point of the wireless interface, has a function to play a role of mediation between wireless devices, and is configured to be able to install the wireless LAN card 3-4 of the PCMCIA card type. When each device incorporated with a wireless LAN module is used, the installation of the wireless LAN card 3-4 of the PCMCIA card type is not required.

Between the PC 3-1 and the printer 3-2, it is possible to transmit print data by using the USB cable 3-5, and it is also possible to transmit print data to the printer 3-2 via the access point 3-3 by using the wireless LAN interface. In FIG. 3, although only one computer (e.g., PC 3-1) is illustrated, a plurality of PCs can be connected to one access point, and one printer can be shared by a plurality of PCs so as to perform printing.

In the wireless LAN, there is a mode capable of connecting with a plurality of wireless LAN devices through an access point, which is referred to as an infrastructure mode. In the infrastructure mode, it is possible to configure a LAN from a plurality of wireless LAN devices through the access point by setting up the same ID as the ID (SSID) set up in the access point in the wireless LAN device also. When a printer is used as a wireless LAN device, the printer is required to be set up in such a manner as to be able to connect with the access point. To facilitate a thorough understanding of the present embodiment, presume that setups between the PC 3-1 and the access point 3-3 are already made, and the PC 3-1 is in a state capable of communicating with the access point in the infrastructure mode. Additionally, presume that, with respect to the printer 3-2, the setups of the wireless LAN are not yet made, and the ID is not yet set up as an initial state in the infrastructure mode.

In the PC3-1, some OS (operating system) is operating, and in order to perform printing in such OS environment, it is necessary to install software for printing (printer driver) in the PC 3-1. Further, when printing is performed by using the wireless LAN, the setups of the wireless LAN in the printer 3-2 are performed, so that the printer 3-2 is put into a state capable of connecting with the access point 3-3. In the PC 3-1, software capable of printing using the wireless LAN is installed in the PC 3-1, and software enabling printing using the wireless LAN is required to be set up suitably to the printer 3-2.

With the use of the foregoing system configuration, the setups of the printer 3-2 are executed. As described earlier, the case is presumed where the installation of a network printer is performed for a plurality of PCs. In the environment including a plurality of PCs, a method of reducing a complicated operation of repeating a change of the device identification name of a port each time and a method of sharing an intelligible port name by users for the plurality of PCs will be described. Further, in an embodiment, the port name may not always be shared, but the situation where even different users make use of PCs and the port names are desired to be given independently can be coped with.

For example, the PC 3-1 which installs the printer driver first is referred to as the computer 1 in FIG. 1. The PCs which install the printer driver subsequent to the first PC are referred to as the computer 2 and the computer 3 for convenience. Presume that the foregoing three computers are set up in a state in which they are mutually capable of communicating with one another in a local area network. Presume that, instead of the wired LAN cable in FIG. 1, a wireless access point is installed, so that all the devices are in a state capable of communicating through that wireless access point. A printer 3-2 desired to be set printable on a client is taken as a network printer A. To this network environment is added the network printer A, thereby allowing printing to be made from respective PCs. The installation procedure in this case of the printer driver is as follows.

First, when installing the printer driver on the computer 1, communication configuration of the network printer A is also set up subsequently. At this time, when a user changes the port name created in the computer 1 to an intelligible name, for example, “printer in library”, this name is automatically transmitted to the network printer A as a device identification name without allowing the user to be aware of it, and is registered on the storage area 2-8.

After completion of the setups of the network printer A, the network printer A is detectable from the computer 2 and the computer 3 via the network. However, in a case where a plurality of setup-printers exist, though it is necessary that the user is allowed to select the printer to be installed on the PC, the device cannot be easily identified only by a MAC address or a IP address. Particularly, in the wireless environment, there are some cases where a printer next door is unintentionally detected. At this time, the device identification name “printer in library” set up in the network printer A is displayed together with printer information such as printer names of a printer list on the screens of the computer 2 and the computer 3. At this time, it is possible also for the user to change the port name. When the port name is not changed, the port name is assigned with the “printer in library”. Then, a port driver is installed to create a port.

When the foregoing procedure is executed for the computer 1, the computer 2, and the computer 3, the port name assigned first by the user is also automatically assigned for the computer 2 and the computer 3, so as to enable using the port name in a simple manner.

Incidentally, in the present embodiment, while a description is made on the installation of the wireless LAN, it is possible to use the device identification name in a similar manner in a wired LAN. Therefore, when the printer 3-2 has a plurality of interfaces at the same time, an individual device identification name can be registered for respective interfaces, and it is convenient if management or initialization can be made individually as occasion demands.

Hereinafter, to clarify the present embodiment, first, installation of the printer driver will be described, and after that, installation of the printer driver using a USB in the present embodiment, and then, installation of the wireless LAN using the USB will be described.

<Installation of Commonly Used Printer Driver)

To connect a printer such as the printer 3-2 to a host computer such as the PC 3-1 so as to perform printing, software is required, which can understand a printing command from a printing application on an OS of the host computer and transfer a printing control command and printing data based on the printing command to the printer, thereby performing the control of the printer. This software for controlling the printer is the foregoing printer driver.

As represented by the printer driver, all the hardware connected to the host computer are controlled in such mechanism to receive a control command from the application through a device driver. Since the device driver is not exclusive for a specific higher-level application activated on an operating system, during the period when the device is connected to the host computer, device driver stays resident while occupying a specific memory area as a kind of resident program.

The recent OS represented by Windows (registered trademark) has a plug and play function in which, when a peripheral device is connected to the host computer, an appropriate device driver corresponding to that device is automatically assigned. In the case of the plug and play processing when the peripheral device is connected to the host computer for the first time, if there is no optimum device driver available, it may be necessary to incorporate a device driver stored in a storage medium such as a flexible disk or CD-ROM and the like into the OS at the purchase time of the device. This incorporating operation of the device driver is referred to as the installation operation of the device.

The installation processing of the device driver in the OS supporting the plug and play will be described below.

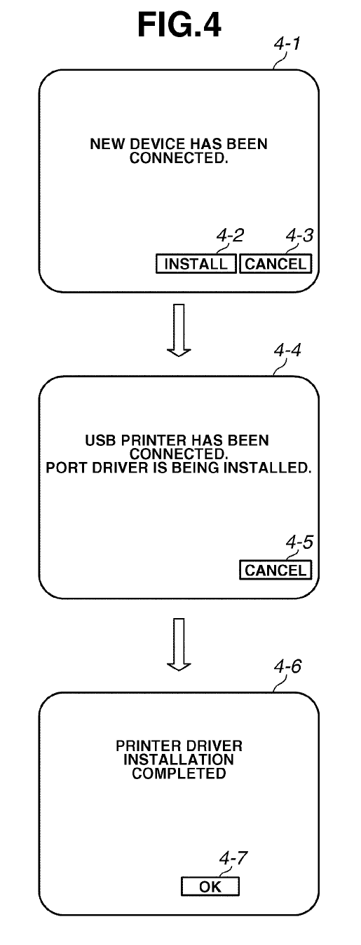

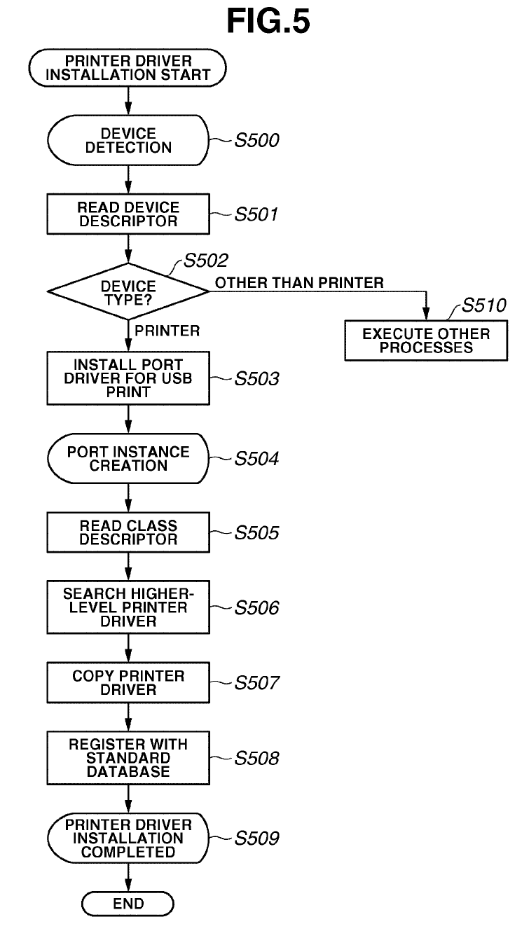

As a representative example of the wired interface supporting the plug and play, the USB can be cited. Here, a description will be made by citing the installation of the printer driver using the USB as an example. Message screens displayed on the host computer are shown in FIG. 4, and a sequence flow in FIG. 5. Incidentally, the sequence flow or the messages are applicable only when the plug and play is normally performed. There exists an error sequence separately when the plug and play fails.

First, the user uses the USB, which is an interface supporting the plug and play, and connects a printer to the host computer. The OS operating on the host computer detects that the device is connected to the host computer via the USB interface (step S500 of FIG. 5). At this time, a screen 4-1 of FIG. 4 is displayed. The user presses a button 4-2 when the user wants to install the printer driver. On the other hand, when the user does not want to install the printer driver, the user presses a button 4-3. Next, the OS reads a device descriptor, which is basic information on the USB device, from the printer by a predetermined method defined by the USB (step S501). The device descriptor includes basic functional information regarding the device such as device class information showing a type of the device. The OS reads and analyzes the device descriptor and determines whether the connected device is a device belonging to the printer class, that is, a printer (step S502). When the connected device is a printer, the OS proceeds to step S503. When the device is a device other than printers, the OS performs other processing, and completes the processing.

In general, a device driver for a printer is generally configured by two levels of the drivers. The driver of the first level is a port driver serving as a lower-level driver, which controls a protocol for performing data communication with the device on the interface for every interface connected with the printer. The driver of the second level is a higher-level printer driver, which is positioned at the higher-level of the port driver and converts actual printing application data into recording data or printer language suitable to individual printers. The higher-level printer driver acquires an operating status of the printer, that is, status information from the printer, and delivers the status information to a printer status display application.

When recognizing that the connected device is a printer, the OS installs an appropriate port driver by using a predetermined method and puts the port driver into a usable state (step S503). At this time, the OS displays a screen 4-4 of FIG. 4. The user presses a button 4-5 when the user wants to stop the installation of the port driver. During installation, a port instance is created under the control of the port driver. The port instance is a logical connection for performing data communications on a one-for-one basis between a specific device and the host computer detected on the interface. In the case of a USB printer, after the port driver for USB printing is installed, a port instance is created as a logical communication route for performing communications between the printer and the host computer (step S504).

When loaded with the port driver and placed into an operating state through initialization processing, the OS acquires a class descriptor as detailed information on the connected printer by a predetermined method (step S505). In the case of the USB printer, this is performed by issuing a device ID reading command (GET_CAPABILITIES) defined by the USB printer class standard to the printer device via the port driver. The device ID returned from the printer as its response includes information intrinsic to a printer model such as information on the manufacturer of the printer, its model name, and the printer language supported.

The OS acquires detailed information on the connected device (e.g., USB printer device), and based on the detailed information, searches an optimum higher-level printer driver (S506). When the corresponding higher-level printer driver exists in a standard search range, the higher-level printer driver found in the standard search range is installed. When the corresponding higher-level printer driver does not exist in the standard search range, a message to inquire about the storage destination of the printer driver is displayed for the user. In such a case, the user designates a device driver downloaded from the media such as a flexible disk or a CD-ROM packed together at the time of purchase of the device or from the file server of the manufacturer through the Internet, so that the higher-level driver can be incorporated into the OS (step S507). At the time of incorporation of the higher-level driver, according to the predetermined procedure, the higher-level printer driver is copied in a predetermined position (directory) on the host computer.

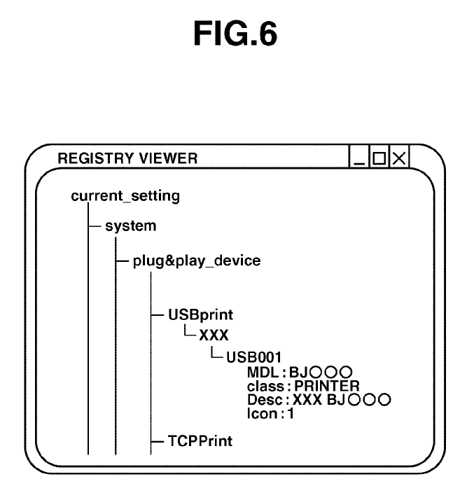

Next, an item (entry) regarding the device currently being installed on the database provided with the OS on standard basis is added (step S508). In this database, information such as setup parameters for control for every device, a driver device configuration, information regarding the lower-level port driver associated with the device instance, port instance information, and setup information by the user, and the like are stored. In an OS such as Windows (registered trademark) 2000 and Windows (registered trademark) XP, this standard database is generally referred to as registry. An example of a registry displayed in a form recognizable by the user is shown in FIG. 6.

This entry is created for every device performing communications via the port instance created by the OS, that is, for every logical device. That is, the entry is provided for every logical connection between the OS and the device, and is associated by storing the corresponding port instance information. For example, when the printer including a plurality of connecting interfaces is connected to the host computer via respective interfaces, the port instance is created for every interface. Although the higher-level printer drivers used by the same printer are common, the entry is created on the registry for every interface or every logical connection.

As described above, when a start preparation of the printer driver is completed, a message to the effect that the installation has been completed is displayed as a screen 4-6 of FIG. 4 (step S509). In the screen 4-6, when an icon “OK” 4-7 is pressed, the processing ends.

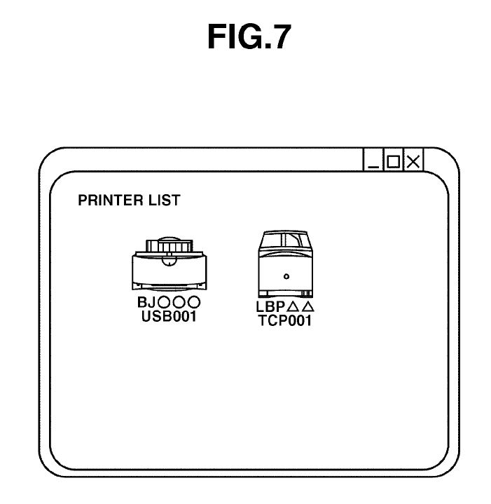

In a printer list screen of a commonly used OS including a GUI, the port instance for a printer is visually displayed in terms of a printer icon. This example is shown in FIG. 7. That is, when a plurality of port instances via a plurality of interfaces are created for a printer, a printer icon is displayed for each instance, respectively. Since information regarding the association with this printer icon and the port instance is also described in the entry created for every port instance, information such as by which printer icon each port instance is visually represented is managed.

Thus, a description has been made on the installation processing of the commonly used device driver in the OS supporting the plug and display with the USB printer as an example. Needless to mention, although there are some cases where the installation of the device driver is performed by different methods depending on the type of OS, the installation of the plug and play device is performed according to similar sequence of operations as described above.

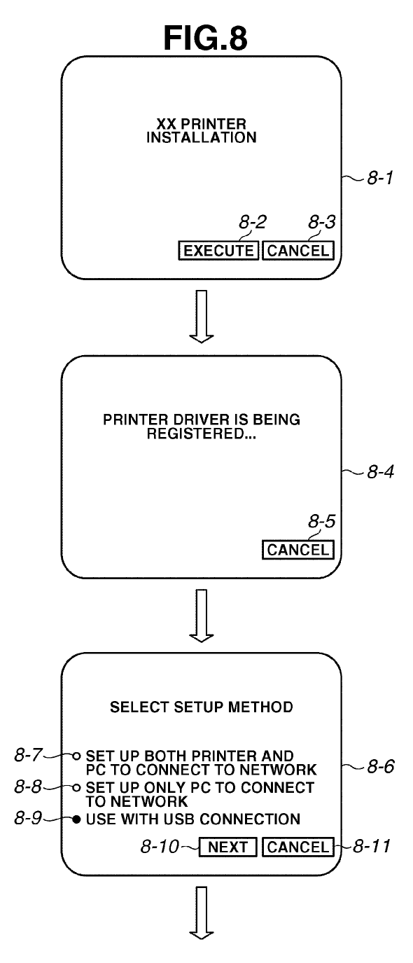

FIG. 8 shows exemplary screen captures displayed during a printer driver installation processing using the USB according to the present embodiment. These screen captures are displayed on the screen of the display unit 2-2 (FIG. 2) of the PC 3-1 when the printer driver is installed in the PC 3-1 in order to perform printing by the printer 3-2 of FIG. 3. In the printer driver installation processing using the USB according to the present embodiment, there is an alternative available regarding which of the USB interface and the wireless network interface the user will use to perform printing. Here, similarly to <Installation of Commonly Used Printer Driver>, a description will be made on the case using the USB interface, and regarding the case where the wireless network interface is used, a description will be made in <Installation of Wireless Network of the Present Embodiment>.

As the first screen, a screen 8-1 is displayed. This screen 8-1 is a starting screen of the installation processing of the printer driver, and is displayed by activating installation software by the user. On the screen 8-1, there are selection icons 8-2 and 8-3 for selecting an icon “Execute” and an icon “Cancel”, respectively, which can be selected using a mouse and the like. When the icon “Execute” 8-2 is selected, installation starts, and the next screen 8-4 is displayed. When the icon “Cancel” 8-3 is selected, an installation of the printer driver is not performed, and the installation process is terminated.

A screen 8-4 is a screen to show the user that the printer driver is being registered in the PC 3-1. Usually, since it takes time to copy files, a progress bar for showing the elapsing time needed until termination is displayed, and when completed, the screen 8-4 automatically proceeds to a screen 8-6. In the screen 8-4, the installation can be stopped by selecting the icon “Cancel” 8-5.

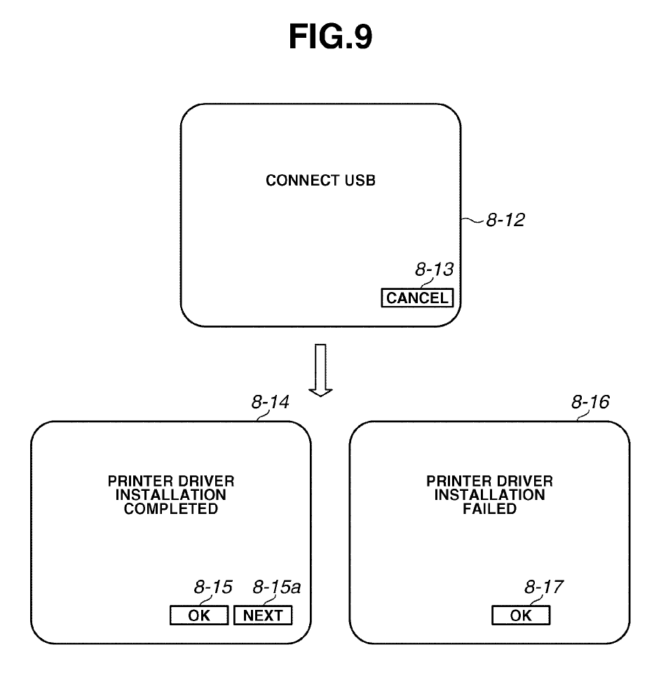

In the screen 8-6, there are alternatives for a setup method of the printer 3-2, and either of selection icons 8-7, 8-8, and 8-9 is allowed to be selected. FIG. 9 shows screens displayed when the selection icon 8-9 is selected (screens 8-12, 8-14). In the screen 8-6, the installation can be stopped by selecting the icon “Cancel” 8-11.

When an icon “SET UP BOTH PRINTER AND PC TO CONNECT TO NETWORK” 8-7 is selected and an icon “Next” 8-10 is selected, wireless network setup is started using the USB. Regarding the display screen and processing when the selection icon 8-7 is selected, a description will be made in <I: Wireless Network Installation using USB> of <Wireless Network Installation of the Present Embodiment>

When an icon “SET UP ONLY PC TO CONNECT TO NETWORK” 8-8 is selected and the icon “Next” 8-10 is selected, the wireless network setup is started. Regarding the display screen and processing when the selection icon 8-8 is selected, a description will be made under the heading of <II: Wireless Network Installation using Wireless Interface>.

When an icon “Use with USB connection” 8-9 is selected and the icon “Next” 8-10 is selected, the setup for using the printer by the wired connection is performed. That is, the processing of FIG. 5 is activated, and the setup for using the printer by the USB connection is started.

Incidentally, since the printer 3-2 of an embodiment has both of the USB interface and the wireless/wired LAN interface, a selection of the screen such as the screen 8-6 is made on the assumption that the setups of the wireless LAN (wireless network installation) are performed sequentially after the termination of the installation of the printer driver.

Further, with respect to the user selectable options associated with the screen 8-6, there are two types of intentions included in a broad way. The first intention is a selection of the types of interfaces for performing communications between the PC 3-1 and the printer 3-2.

When the wireless/wired networks are desired to be used, the selection icon 8-7 or 8-8 is selected. The printer is not used through the wireless network, and when only the USB connection is desired to be used, the selection icon 8-9 is selected. In the embodiment, this is the alternative in a case where the wireless/wired networks are used or the USB only is used. Hereinafter, it does not matter if the types of selectable interfaces are added with other interfaces.

The second intention of the user selectable options associated with the screen 8-6 is providing an alternative as to whether the printer 3-2 is in a set state immediately after shipment from the seller or whether the setup only of the PC 3-1 is desired to be performed with the setup of the printer 3-2 left alone as they are while already set according to the network of the peripheral environment. When the printer 3-2 is in a state immediately after shipment from the seller, the selection icon 8-7 is selected, and when the printer 3-2 is already set up, the selection icon 8-8 is selected.

Next, the selection icon 8-9 is selected in the screen 8-6 and the button 8-10 is depressed by the user. Then, in a screen 8-12 (FIG. 9), there is displayed an instruction prompting the user to connect the USB interface, and according to that instruction, the user connects the USB cable 3-5 to the USB interface of the printer 3-2. When the power supply of the printer 3-2 is not turned on, the user turns on the power supply of the printer 3-2. In the screen 8-12 also, the installation can be stopped by pressing the icon “Cancel” 8-13.

When the USB cable 3-5 is connected and the power supply of the printer 3-2 is turned on, the installation of the printer driver and the inner setups of the printer 3-2 are completed by the plug and play. The installation of the printer driver by the plug and play is performed according to the procedure described in <Installation of Commonly used Printer Driver> of FIG. 5.

When the installation process is successfully completed, a screen 8-14 is displayed to inform the user that the installation is completed. When the user selects an icon “OK” 8-15, the software is completed. When the installation of the printer driver fails for some reason, a screen 8-16 is displayed to inform the user that the installation has failed. Similar to the screen 8-14, the software is completed by selecting an icon “OK” 8-17.

As described above, by performing the operation according to the instructions in the screens 8-1, 8-4, 8-6, 8-12, and 8-14, the installation of the printer driver using the USB interface is completed, and printing is made possible through the USB interface.

<Installation of Wireless Network of the Present Embodiment>

I: Installation of Wireless Network using USB

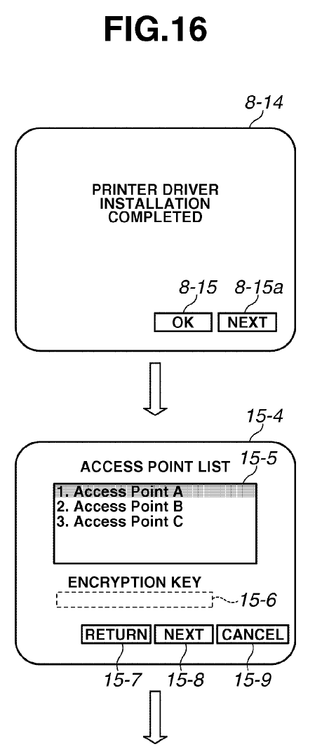

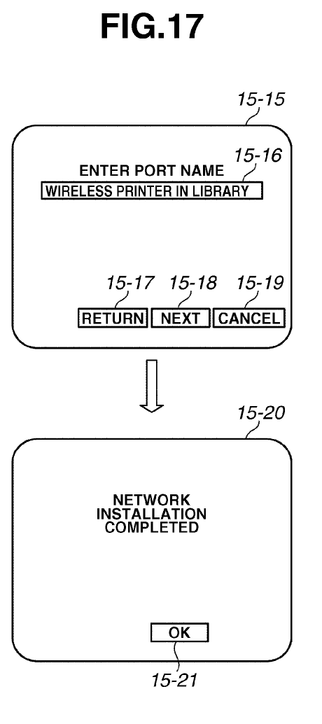

FIGS. 16 and 17 show screens displayed in order after the screen 8-12 prompting the connection of the USB cable when the icon “SET UP BOTH PRINTER AND PC TO CONNECT TO NETWORK” 8-7 in the screen 8-6 of FIG. 8 is selected. In the screen 8-6 of FIG. 8, when the icon “SET UP BOTH PRINTER AND PC TO CONNECT TO NETWORK” 8-7 is selected, the screen 8-12 (FIG. 9) prompting the connection of the USB cable is displayed. A screen displayed after the PC is connected to the printer through the USB cable is the screen 8-14 of FIG. 16. In the screen 8-14 of FIG. 16, when an icon “Next” 8-15a is selected, the screen proceeds to a screen 15-4.

The screen 15-4 displays a list of access points connectable with the printer 3-2 by using the wireless LAN card 3-4 installed in the printer 3-2. For that purpose, a command for access point search is sent to the printer 3-2 from the PC 3-1 via the USB cable 3-5. Upon receipt of the command for access point search from the PC 3-1 through the USB cable 3-5, the printer 3-2 searches for the access points using the wireless LAN card 3-4. Access point information acquired as a result of the search is sent to the PC 3-1 through the USB cable 3-5, and based on the acquired information, the access point list is displayed in the screen 15-4.

A display field 15-5 in the screen 15-4 shows a access point list discovered from the printer 3-2 side by access point search, and this example shows that three access points A, B, and C are found from the printer 3-2 side. Further, since the display field 15-5 displays all the access points operating in the range reachable with radio waves, the access point list may not be limited only to the access points used by the user. Consequently, a highlighted line in the screen 15-5 can be simply scrolled so that a desired access point can be selected by the user from a plurality of access points.

When the selected access point is encrypted, an encryption key for decrypting the encryption can be entered in an entry field 15-6 to deal with encrypted access points also. In general, in the wireless LAN, encryption technology is adopted in order to prevent electronic eavesdropping and leakage of data. As a representative example, there is WEP (Wired Equivalent Privacy). This is an algorithm used for encryption and decryption of information referred to as encryption key in both way, and by setting up this key, concealment of the data from other devices is realized. When the wireless LAN is used in the encrypted environment, it is necessary to set the same encryption key to the printer 3-2 also.

When an icon “Return” 15-7 in the screen 15-4 is selected, the screen returns to the previous screen 8-14, and when an icon “Next” 15-8 is selected, the screen proceeds to the next screen in a state in which the access point selected in the entry field 15-5 is designated. When an icon “Cancel” 15-9 is selected, the installation can be stopped.

Thus, in the screen 15-4, since the user can select and designate the access point currently used by the user, when printing data is transmitted to the printer 3-2, an erroneous connection to other access points can be prevented. In the screen 15-4, when the user selects an access point, the setups of the access point to be used are performed by the printer 3-2, and the printer 3-2 can be recognized from the access point 3-3. The PC 3-1 searches the printer via the wireless LAN in order to confirm whether the printer 3-2 is correctly connected.

To confirm whether the connection is correctly made, the PC 3-1 sends a command for printer search via the access point by using the wireless LAN interface, and the printer returns a reply upon receipt of the command for printer search. That is, this search command is transmitted to all the devices on the network by broadcast, and the device (specific printer or printer adapter in this case) which receives the search command and can understand this command returns the predetermined information corresponding to the command to the host computer having transmitted the command. This information includes the name, ID, address, and the like of the printer, and based on these pieces of information, a printer to be connected is specified. It is possible also to confirm communicatability via the access point by transmitting the command to a specific printer on the network with the address designated and looking through its response, and either way of confirmation is acceptable.

Next, a screen 15-15 (FIG. 17) for entry of a port name is displayed. An entry field 15-16 in the screen 15-15 is a field for entering the desired port name. The port name, when a plurality of printers connected with one PC has the same function (for example, wireless LAN), is used for differentiating these printers. As an initial value, for example, “WLAN_{—}00:11:22:AA:BB:CC” is set up. “WLAN” is an identification name (prefix) for showing the printer of the wireless LAN, and “00:11:22:AA:BB:CC” represents a MAC address of the interface of the printer, and is attached to the port name in order to differentiate a plurality of printers. Not limited to the attachment of the MAC address, but an identifiable address in units of the individual printer such as IP address and the like or in units of the interface such as the wireless LAN and the wired LAN may be attached.

When an icon “Return” 15-17 in the screen 15-15 is selected, the screen returns to the previous screen 15-4, and when an icon “Next” 15-18 is selected, the name entered in the entry field 15-16 is decided as the port name. Further, the selection of an icon “Cancel” 15-19 stops the installation. When the icon “Next” 15-18 is selected in the screen 15-15, a screen 15-20 showing the termination of the network installation is displayed. In the screen 15-20, when an icon “OK” 15-21 is pressed, the processing ends.

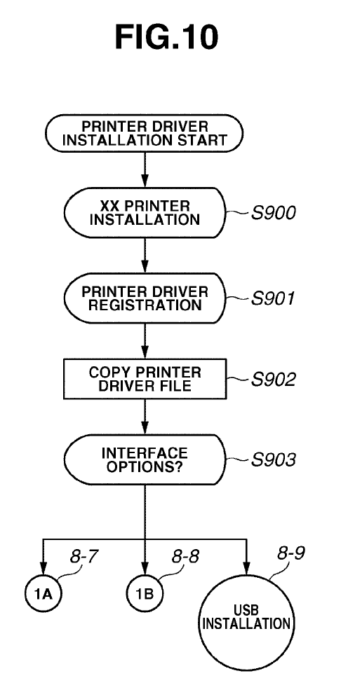

In response to an instruction for starting installation, a process shown FIG. 10 starts on the PC 3-1. At step S900, an installation of a printer begins. At step S901, a printer driver is registered to a registry of an Operating System. At step S902, files of the printer driver are copied to a file system of the PC 3-1.

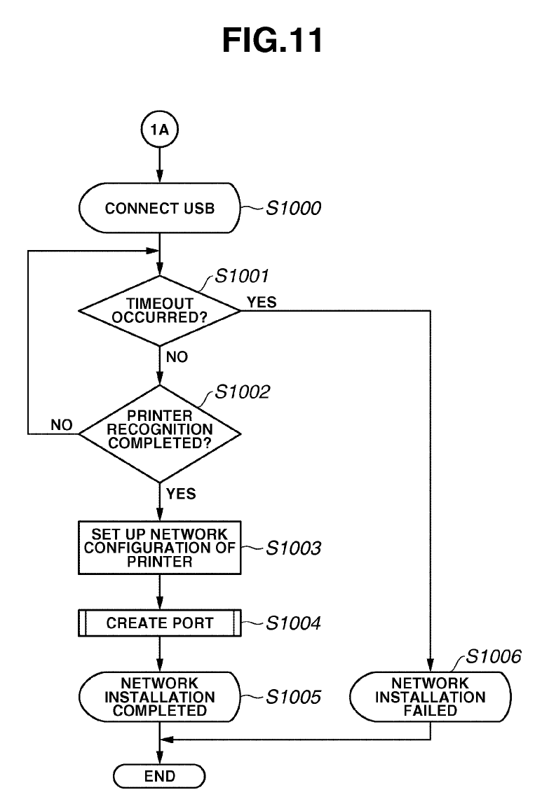

FIG. 11 is a flowchart showing the processing executed by the PC 3-1. FIG. 11 corresponds to the wireless network installation processing of the present embodiment in which the screens shown in FIGS. 16 and 17 are displayed.

First, in step S903 of FIG. 10, the processing determines whether the wireless network installation is selected. At step S903, the screen 8-6 of FIG. 8 is displayed. When the icon “SET UP BOTH PRINTER AND PC TO CONNECT TO NETWORK” 8-7 is selected, the processing proceeds to step 1A of FIG. 11. At step S1000 of FIG. 11, the connection of the USB is confirmed, and the processing determines whether or not timeout has occurred (S1001). At step S1002, the processing detects whether or not the PC 3-1 is connected with the printer 3-2 by the USB interface. As an error handling in a case where a period of time has passed without USB connection confirmed, a time out value is set up, which is confirmed at step S1001, and when the time out occurs, an error screen is displayed at step S1006.

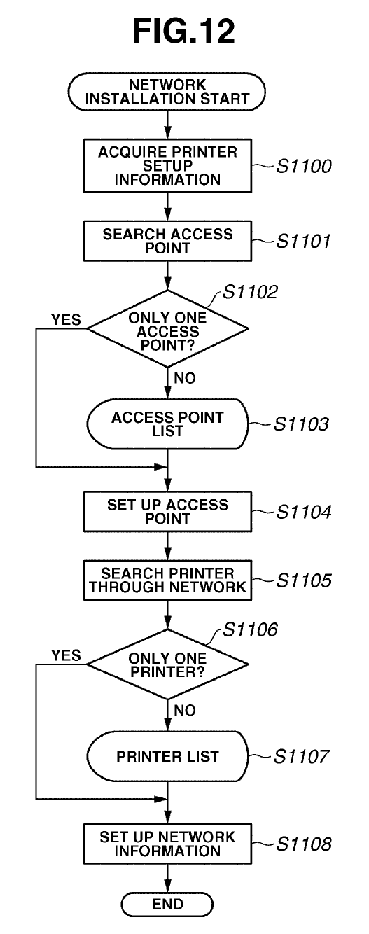

When it is confirmed that the printer 3-2 is connected by the USB cable 3-5 (“YES” at step S1002), the process proceeds to step S1003 where the wireless LAN network configuration of the printer 3-2 is setup. This network configuration processing will be described with reference to FIG. 12.

FIG. 12 is a flowchart illustrating the details of the network configuration processing (S1003) of the printer according to an embodiment of the present invention. In FIG. 12, first, setup information on the printer 3-2 is acquired (S1100). This is executed by sending an information acquiring command from the PC 3-1 to the printer 3-2 via the USB cable 3-5, and the printer 3-2 returns the setup information to the PC 3-1 via the USB cable 3-5. The information set up in the printer 3-2 includes information regarding the wireless LAN.

Here, to register a port name for default display later, it is possible also to acquire the MAC address of the wireless interface of the printer as an identifier.

Next, a command for access point search is transmitted to the printer 3-2 through the USB cable 3-5 (S1101). The printer 3-2 performs a search for access points, and returns the information on the found access points to the PC 3-1 via the USB cable 3-5.

Here, a command is available as a USB command for wireless network installation, which is transmitted to the printer 3-2 by the PC 3-1 via the USB cable 3-5. When the access point search command is sent to the printer 3-2, the printer 3-2 performs the setups for searching for access points for the wireless LAN module by using the wireless LAN module such as the wireless LAN card 3-4. The wireless LAN module given the setups of the access point search sends an access point search signal. The access point having received this signal returns its own access point information (ID, electric wave status, address, channel, and the like) to the party having sent out the signal. The wireless LAN module receives the information returned from the access point, and the received information is returned to the PC 3-1 by the printer 3-2. At this time, the printer 3-2 returns the found information on all of the access points to the PC 3-1.

At step S1102, the processing checks how many access points are found from the access point information returned to the PC 3-1 from the printer 3-2. When two or more access points are found (“NO” at step S1102), the processing proceeds to step S1103 to display the screen 15-4 showing a access point list, and allows the user to select an access point. When only one access point is found (“YES” at step S1102), the processing skips step S1103 and proceeds to step S1104.

At step S1104, the setups of the access point used for the wireless LAN are performed. This is performed by sending the information setup command designating the access point selected by the user or the only access point found to the printer 3-2 via the USB cable 3-5 based on the information on the access point found by the access point search (S1101). The information necessary for using the access point such as the address of the access point, the encryption key, and the like is set up by an information setup command, so that the printer 3-2 can be connected to a specific access point.

At step S1105, a network command is used, and a printer search is conducted. As the network command, two commands for network installation of a printer search command (broadcast) and a printer search command (address designation) are available. Both are print search commands. More specifically, the first printer search command (broadcast) does not designate a partner, and the second printer search command (address designation) designates a specific partner.

Here, the PC 3-1 transmits the printer search command of broadcast type. This command is transmitted via the wireless LAN, and each printer having received this command from the wireless LAN returns the printer information (ID, name, address, model name, and the like) to the PC 3-1. In this manner, the connection confirmation with the PC 3-1 and each of the responding printers can be made via the wireless LAN. Since this command is transmitted by broadcast, all of the printers which can understand this command are likely to respond to the PC 3-1 having transmitted that command. It is necessary for the PC 3-1 to select one of the responding printers (e.g., based on the model of the printer intended for installation) based on the information returned from the printer.

The PC 3-1 checks from the information returned from the printers whether or not only one of the printers corresponds to the printer 3-2 connected by the USB cable 3-5 in terms of identification information such as the model name, device ID, and the like (step S1106). Even if only one corresponding printer is found, when the found printer is different from the printer connected by the USB cable 3-5 or when the two or more corresponding printers are found (“NO” at step S1106), the processing proceeds to step S1107, where a printer list detected is displayed to allow the user to manually select the printer. If only one printer is found and it corresponds to the printer connected by the USB cable 3-5 (“YES” at step S1106), the processing skips step S1107 and proceeds to step S1108.

In one embodiment, the PC 3-1 is configured to transmit a printer search command designating an address. In this case, no printer other than the designated printer will be detected.

When the printer configuration is completed, at step S1108, PC configuration is started. The PC 3-1 performs network information setups and registration of the port instance for wireless LAN within the PC 3-1. Thus, the PC 3-1 is put into a state capable of transmitting printing data to the printer 3-2 via the wireless LAN interface. The network information shows information such as the address, name, and the like of the printer necessary for printing.

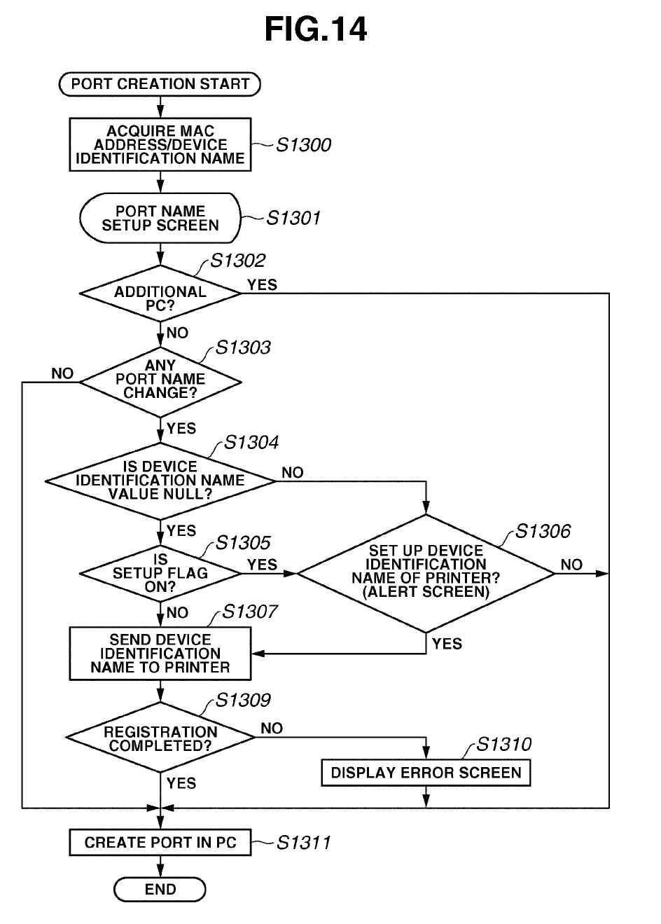

The processing of registering the port instance for wireless LAN in the PC 3-1 will be described in detail below with reference to FIG. 14.

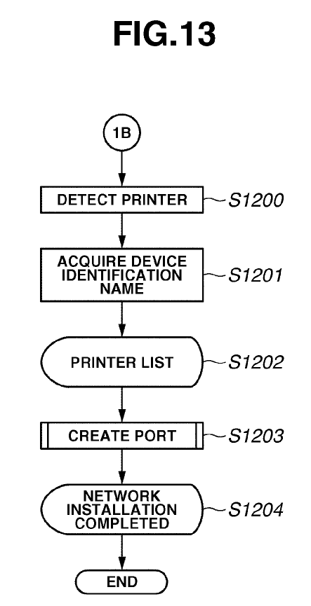

FIG. 14 is a flowchart of port creation processing according to an embodiment of the present invention. This processing includes the case where the setup of <1: Wireless Network Installation using USB> is performed by selecting the button 8-7 in the screen 8-6 of FIG. 8 (step S1004 of FIG. 11) and the case where the setup of <II: Wireless Network Installation using Wireless Interface> is performed by selecting the button 8-8 in the screen 8-6 of FIG. 8 (step S1203 of FIG. 13). Here, although a description will be made on the case where the setup of <1: Wireless Network Installation using USB> is performed, the processing in a case where the button 8-8 is selected is similar.

First, at step S1300, in order to display a default port name, the PC 3-1 transmits an information acquiring command via the USB cable 3-5 and acquires the MAC address which is identification information on the printer and the device identification name registered in the storage area 2-8 of FIG. 2. Further, at this point of time, since the network setup of the printer 3-2 is completed, this processing may be performed by using the printer search command of the network command. However, when this information is already acquired at the above-mentioned step S1100, there is no need to perform this processing.

At step S1301, a port name is displayed in the entry field 15-16 of the port name entry screen 15-15. When the device identification name is already set up in the printer 3-2, the device identification name is acquired by the PC 3-1 from the printer 3-2, thereby to display it, but when it is not yet set up, the MAC address such as “WLAN_{—}00:11:22:AA:BB:CC” is displayed.

At step S1302, when <1: Wireless Network Installation using USB> is selected by the user (that is, when the button 8-7 is selected in the screen 8-6 of FIG. 8 at step S903 of FIG. 10), it is decided as the installation of the first computer 1 of FIG. 1 as previously described, the processing proceeds to step S1303.

Next, at step S1303, the processing checks whether a character string of the port name displayed as default in the screen 15-15 is changed. When the port name is changed (“YES” at step S1303), the processing proceeds to step S1304.

Here, in the alternatives of the setup method of the screen 8-6, it is necessary to consider the case where despite of the fact that the network setups of the printer are already made, the button 8-7 is erroneously selected. For example, it is similar to the case where the printer is purchased by the family, and a person who does not know that the printer is already set up through the button 8-7 by another person sets up the printer again through the button 8-7.

At this time, there is a case 1 where the printer network configuration is in a communicatable state, that is, is already set up and the device identification name is registered in the printer. Further, there is a case 2 where, although the printer network configuration is already set up, because the port name is not changed, the device identification name is not yet registered in the printer. In the present embodiment, since the device identification name can be registered in the printer without allowing the user to be aware of it, in the foregoing case, the user must be exceptionally allowed to be aware of the fact that the device identification name is changed.

In the case 1, in order to prevent the device identification name from being changed without the user being aware of it, at step S1304, the processing checks whether the device identification name is already set up. When the device identification name value acquired from the printer is a null value showing that it is vacant (“YES” at step S1304), the processing proceeds to step S1305. However, when anyone else has already set up the device identification name (“NO” at step S1304), the processing proceeds to step S1306. At step S1306, a warning screen indicating “Do you want to set up a device identification name of the printer?” is displayed in the PC 3-1. When “Yes” is pressed in the warning screen (“YES” at step S1306), the processing proceeds to step S1307. When “No” is pressed (“NO” at step S1306), the processing proceeds to step S1311.

In the case 2, in order to prevent the device identification name from being changed without the user being aware of it, at step S1305, the processing checks whether the network configuration of the printer is already set up or not yet set up. A flag for confirmation of the established setups is created in the printer 3-2, and the flag of the printer indicating the unestablished setups is set to “0”, and if the setups are executed even once, the flag of the printer is set to “1” (as long as the printer is not initialized). At step S1305, the flag for confirmation of the established setups acquired by using the information acquiring command of the USB command is checked. When the flag is set to “0” (“NO” at step S1305), the processing proceeds to step S1307. When the flag is set to “1” (“YES” at step S1305), the same warning screen as displayed in the case 1 at step S1306 is displayed in the PC 3-1. When “Yes” is pressed in the warning screen, the processing proceeds to step S1307. When “No” is pressed, the processing proceeds to step S1311.

However, if a check of the case 1 is made, a check of the case 2 may not be made.

At step S1307, the same name (character string without prefix may be acceptable) as a port to be created in the PC as the device identification name is transmitted to the printer by using the information setup command of the USB command and is registered in the printer. Further, at this point of time, since the network setups of the printer 3-2 are completed, that name may be transmitted by using not the USB command but the information setup command of the network command. When the port name is not changed, no registration of the device identification name is made in the printer. When the registration of the device identification name is completed, the printer informs the PC 3-1 of the completion of the registration via the USB cable 3-5 or the wireless network (step S1309). When the registration is completed (“YES” at step S1309), the processing proceeds to step S1311.

When the registration has failed (“NO” at step S1309), since no device identification name is registered in the printer, at step S1310, an error screen is displayed, and after that, the processing proceeds to step S1311.

Incidentally, when the same character string as the port name is registered in the printer as the device identification name, it is necessary to impose a limit on the number of characters and the type of character. This is to prevent errors from occurring for the reason that the maximum number of characters and limited character types are different for creation of the port name since the device identification name can be referred to by the operating systems of different types and versions.

Finally, at step S1311, a port is created for the system of the PC 3-1. Incidentally, if the timing at which the port name is registered in the PC 3-1 and the timing at which the device identification name is registered in the printer 3-2 are almost the same, it does not matter at all even if there exist a few time differences or the sequence is reversed.

In the present embodiment, the USB command transmitted to the printer via the USB command cable 3-5 includes three commands. The first one is a command for searching for the access point. The second one is an information acquiring command, which is used in order to acquire from the printer information regarding the wireless LAN set up in the printer. The third one is an information setup command, which is a command for setting up the information regarding the wireless LAN (for example, an address of the access point, a mode, a channel and the like). The USB command further includes a command for sending printing data, a command for setting up various types of printers, and the like.

In the present embodiment, there are available two types of network commands transmitted to the printer via the wireless LAN. They are a printer search command for broadcast received by all of the printers and a printer search command for address designation received by specific printers. The network command further includes a command for sending printing data, a command for setting up various printers, and the like. Here, as an example, the installation command only is cited.

By using this command, it can be determined whether the printer existing on the network is correctly found, and moreover, correctly set up. In other words, the connection confirmation with the printer via the wireless LAN can be performed. These commands can be transferred and sent back via the protocols such as the commonly used TCP/IP, UDP, and the like on the network.

<II: Wireless Network Installation using Wireless Interface>

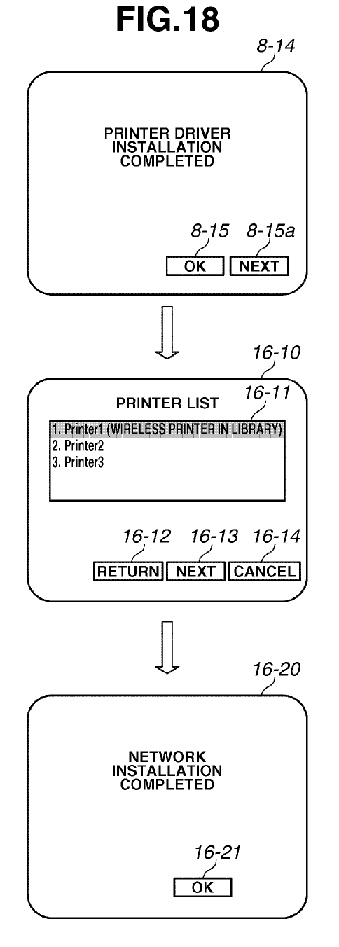

FIG. 18 shows screens displayed in order when the icon “SET UP ONLY PC TO CONNECT TO NETWORK” 8-8 is selected in the screen 8-6 shown in FIG. 8.

The icon 8-8 is selected when the wireless network configuration of the printer described in <I: Wireless Network Installation using USB> is already completed through the first PC, and the set up procedure for enabling the second and subsequent PCs to perform printing is executed.

In FIG. 18, a screen 8-14 is displayed when the icon “SET UP ONLY PC TO CONNECT TO NETWORK” 8-8 is selected in the screen 8-6 of FIG. 8 and the icon “Next” 8-10 is selected. In the screen 8-14 of FIG. 18, when an icon “Next” 8-15a is selected, the screen proceeds to a screen 16-10.

The screen 16-10 displays a list of printers found via the access point. The acquisition and display of this printer list are performed by the PC 3-1 (which is equivalent to the computer 2 or the computer 3 of FIG. 1 in the description of <II: Wireless Network Installation using Wireless Interface>) transmitting the command for printer search via the access point using the wireless LAN interface and by the printer having received the command for printer search sending back a response. That is, this search command is transmitted to all the devices on the network by broadcast, and the device (a specific printer or a printer adapter in this case) which receives the search command and can understand this command returns predetermined information corresponding to the command to the host computer having transmitted the command. This information includes the model name, device ID, MAC address, and the like of the printer, and based on these pieces of information, a printer desired to be connected is allowed to be specified. At this time, a value of the device identification name is also acquired.

In the screen 16-10, a printer list found is displayed in a display field 16-11. In this example, three printers are found. Since the printer desired to be used is included in these printers, the user selects the desired printer from the display field 16-11 with the name and the MAC address of the printer as a clue.

When the user inputs the port name in a case where the printer 3-2 is set up by <I: Wireless Network Installation using USB>, the printer 3-2 is displayed as “Printer 1 (Wireless Printer in Library)” as shown in the display field 16-11. When the device identification name is not yet registered, the port name becomes an inscription without the device identification name.

The selected printer is displayed with highlight. When an icon “Return” 16-12 in the screen 16-10 is selected, the screen returns to the previous screen 8-14. When an icon “Next” 16-13 is selected in the screen 16-10, the screen proceeds to a screen 16-20, and when an icon “Cancel” 16-14 is selected, the installation ends.

The screen 16-20 indicates the completion of the network installation. When an icon “OK” 16-21 is pressed, the processing ends.

FIG. 13 is a flowchart showing the processing executed by the PC 3-1 with regard to the wireless network installation of the present embodiment in which the screens shown in FIG. 18 are displayed.

First, in step S903 of FIG. 10, the processing determines whether the wireless network installation is selected. At step S903, the screen 8-6 of FIG. 8 is displayed, and when the icon “SET UP ONLY PC TO CONNECT TO NETWORK” 8-8 is selected, the processing proceeds to step S1200 (FIG. 13).

At step S1200, printer search is performed using the network command. As the network command, two commands for network installation of a printer search command (broadcast) and a printer search command (address designation) are available. Both the commands are commands for printer search. The printer search command (broadcast) does not designate a partner, and the printer search command (address designation) designates a partner.

Here, the PC 3-1 sends the printer search command of broadcast type. This command is transmitted on the wireless LAN, and each printer having received this command from the wireless LAN sends back the printer information (device ID, name, MAC address, IP address, model name, and the like) via the wireless LAN to the PC 3-1 having transmitted the command. This printer information includes the device identification name registered in the storage area 2-8 of FIG. 2. Since it is not clear at this point whether the device identification name is already registered, the acquisition of the device identification name is preferably made. Further, since this command is transmitted by broadcast, all the printers which can understand this command are likely to respond to the PC having transmitted that command.

The PC 3-1 displays received printer information as a list (step S1202). Further, a printer port is registered (step S1203). When the printer port is registered, a process of FIG. 12 is completed (step S1204).

It is necessary for the PC 3-1 to select the intended printer model for installation from the information returned from one or more printers. Hence, based on the printer information sent back from the printer selected in the screen 16-10, the PC 3-1 is set up.

Details of the processing for registering the port instance for wireless LAN in the PC 3-1 are shown in FIG. 14.

FIG. 14 is a flowchart of the port creation processing including the case where the button 8-7 is selected in the screen 8-6 of FIG. 8 and the setup of <I: Wireless Network Installation using USB> is performed and the case where the button 8-8 is selected in the screen 8-6 and the setup of <II: Wireless Network Installation using Wireless Interface> is performed. Here, a description will be made on the case where the setup of <II: Wireless Network Installation using Wireless Interface> is performed.

First, at step S1300, although the MAC address and the device identification name are acquired in order to display a default port name, since they are already acquired at step S1201, there is no need to acquire them again.

At step S1301, similarly to the setup of the first PC, the same screen as the port name entry screen 15-15 is displayed, and the port name is displayed in the entry field 15-16. When the device identification name is already set up in the printer 3-2, it is displayed, but when it is not yet set up, the MAC address such as “WLAN_{—}00:11:22:AA:BB:CC” is displayed.

At step S1302, when <II: Wireless Network Installation using Wireless Interface> is performed (that is, when the button 8-8 is selected in the screen 8-6 of FIG. 8 at step S903 of FIG. 10), since the installation is performed on the computer 2 and the computer 3 described in FIG. 1, the processing proceeds to step S1311.

Incidentally, even if the port name is changed here, the device identification name is not transmitted and registered in the printer, but it is reflected only in the port name of the PC 3-1.

Finally, at step S1311, aport is created for the system of the PC 3-1.

As describe above, in <II: Wireless Network Installation using Wireless Interface>, a description has been made on the case where the network configuration of a plurality of printers is already set up. When a plurality of printers are detected from the computer 2 and the computer 3 of FIG. 1, one printer is selected from among the plurality of printers and is installed on the PC.

Next, a modified example of FIG. 14 will be described below. In <III: Wireless Network Installation 2 using Wireless Interface>, when a plurality of printers are detected, the plurality of printers are selected and the ports of these printers are collectively installed.

<III: Wireless Network Installation 2 using Wireless Interface>

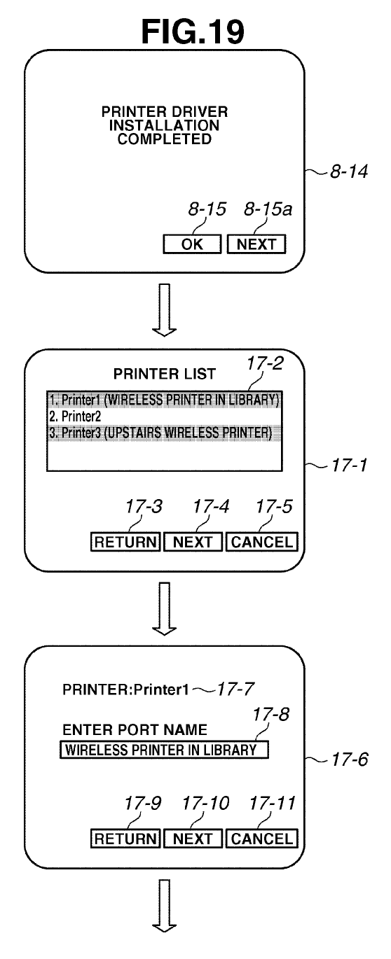

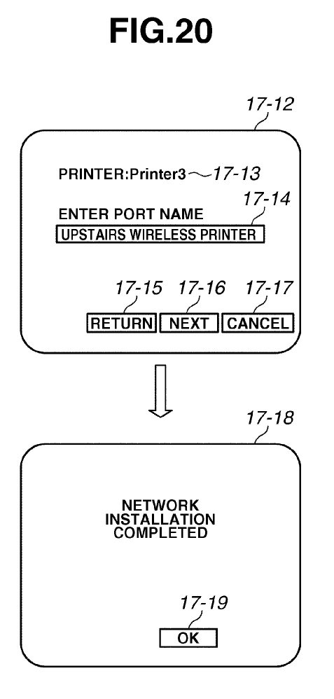

FIGS. 19 and 20 show screens in order which are displayed when the icon “SETUP ONLY PC TO CONNECT TO NETWORK” 8-8 is selected in the screen 8-6 shown in FIG. 8.

The icon 8-8 is selected when the wireless network configuration of the printer described in <I: Wireless Network Installation using USB> is already completed through the first PC, and the setup procedure for enabling the second and subsequent PCs to perform printing is executed.

In FIG. 19, a screen 8-14 is displayed when the icon “SET UP ONLY PC TO CONNECT TO NETWORK” 8-8 is selected in the screen 8-6 of FIG. 8 and the icon “Next” 8-10 is selected. In the screen 8-14 of FIG. 19, when an icon “Next” 8-15a is selected, the screen proceeds to a screen 17-1.

The screen 17-1 displays a list of printers found via the access point. The acquisition and display of this printer list are performed by the PC 3-1 (which is equivalent to the computer 2 or the computer 3 of FIG. 1 in the description of <II: Wireless Network Installation using Wireless Interface>) transmitting the command for printer search via the access point using the wireless LAN interface and by the printer having received the command for printer search sending back a response. That is, this search command is transmitted to all the devices on the network by broadcast, and the device (a specific printer or a printer adapter in this case) which receives the search command and can understand this command returns predetermined information corresponding to the command to the host computer having transmitted the command. This information includes the model name, device ID, MAC address, and the like of the printer, and based on these pieces of information, a printer desired to be connected is allowed to be specified. At this time, a value of the device identification name is also acquired.

In the screen 17-1, a printer list found is displayed in a display field 17-2. In this example, three printers are found. Since the printer desired to be used is included in these printers, the user selects the desired printer from the display field 17-2 with the name, the MAC address of the printer, and the device identification name as a clue.

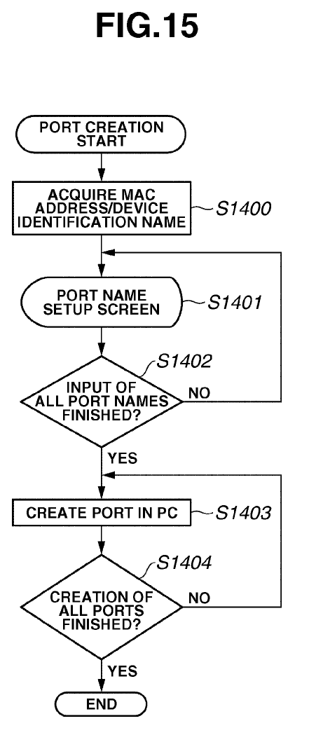

When the port name already set up in the printer in <I: Wireless Network Installation using USB> is input by the user in the previously executed installation, the printer 3-2 is displayed as “Printer 1 (Wireless Printer in Library)” as shown in the display field 17-2. When the device identification name is not yet registered, the port name becomes an inscription without the device identification name. More specifically, at step S1400 of FIG. 15, the device identification name and the MAC address are acquired from the printer, and at step S1401, they are compared with the port name input by the user, and the matched port name is identifiably displayed.

In the screen 17-1, for example, the printer names are displayed as “Printer 1 (Wireless Printer in Library)”, “Printer 2”, and “Printer 3(Upstairs Wireless Printer )”. The printer 1 and the printer 3 have the respective device identification names registered. At this time, the user can select a plurality of printers at the same time. Here, presume that the user selects the printer 1 and the printer 3.

The selected printer is displayed with highlight. When an icon “Return” 17-3 in the screen 17-1 is selected, the screen returns to the previous screen 8-14. When an icon “Next” 17-4 is selected in the screen 17-1, the screen proceeds to a screen 17-6, and when an icon “Cancel” 17-5 is selected, the installation ends.

The screen 17-6 is a port name entry screen for the printer 1. Since a plurality of printers are selected at the same time, the printer name or the model name 17-7 is displayed on the upper portion of the screen 17-6 in order to clarify to which printer the currently setup port name corresponds. Then, the port name is displayed in an entry field 17-8. According to the number of printers selected in the screen 17-1, the port name entry screens similar to the screen 17-6 are displayed in order. When an icon “Return” 17-9 in the screen 17-6 is selected, the screen returns to the previous screen 17-1. When an icon “Next” 17-10 is selected, the screen proceeds to a screen 17-12 (FIG. 20). When an icon “Cancel” 17-11 is pressed, the processing ends.

The screen 17-12 is a port name entry screen for the printer 3. Since a plurality of printers are selected at the same time, the printer name or the model name 17-13 is displayed on the upper portion of the screen 17-12 in order to clarify to which printer the currently set up port name corresponds. Then, the port name is displayed in an entry field 17-14. When an icon “Return” 17-15 in the screen 17-12 is selected, the screen returns to the previous screen 17-6. When an icon “Next” 17-16 is selected, the screen proceeds to a screen 17-18. When an icon “Cancel” 17-17 is selected, the processing ends.

The screen 17-18 indicates the completion of the network installation. When an icon “OK” 17-19 is pressed, the processing is terminated.

FIG. 13 is a flowchart showing the processing executed by the PC 3-1 with regard to the wireless network installation of the present embodiment in which the screens shown in FIGS. 19 and 20 are displayed.

First, at step S903 of FIG. 10, the processing determines whether the wireless network installation is selected. At step S903, the screen 8-6 of FIG. 8 is displayed, and when the icon “SET UP ONLY PC TO CONNECT TO NETWORK” 8-8 is selected, the processing proceeds to step S1200 (FIG. 13).

At step S1200, printer search is performed using the network command. As the network command, two commands for network installation of a printer search command (broadcast) and a printer search command (address designation) are available. Both the commands are commands for printer search. The printer search command (broadcast) does not designate a partner, and the printer search command (address designation) designates a partner.

Here, the PC 3-1 sends the printer search command of broadcast. This command is transmitted on the wireless LAN, and a printer having received this command from the wireless LAN returns the printer information (device ID, name, MAC address, IP address, model name, and the like) via the wireless LAN to the PC 3-1 which have transmitted the command. This information includes the device identification name registered in the storage area 2-8 of FIG. 2. Since it is not clear at this point whether the device identification name is already registered, the device identification name must be acquired. Further, since this command is transmitted by broadcast, all the printers which can understand this command are likely to respond to the PC having transmitted that command. It is necessary for the PC 3-1 to select the model intended for installation from the information returned from the printer. Hence, based on the printer information sent back from the printer selected in the screen 17-1, the PC 3-1 is set up.

Details of the processing for registering the port instance for wireless LAN in the PC 3-1 are shown in FIG. 15.

FIG. 15 is a flowchart of the port creation processing including the case where the button 8-8 is selected in the screen 8-6 of FIG. 8 and the setup of <III: Wireless Network Installation 2 using Wireless interface> is performed.

First, at step S1400, although the MAC address and the device identification name are acquired in order to display a default port name, since they are already acquired at step S1201, there is no need to acquire them again.

At step S1401, the port name entry screen 17-6 is displayed, and the port name is displayed in the entry field 17-8. When the device identification name is already set up in the printer 3-2, it is displayed, but when it is not yet set up, the MAC address such as “WLAN_{—}00:11:22:AA:BB:CC” is displayed.

At step S1402, the processing determines whether all of the port name entry screens for the printers selected with highlight in the screen 17-1 have been displayed. When there exists any port name entry screen not yet displayed (“NO” at step S1402), the processing returns to step S1401. When all of the port name entry screens have been displayed (“YES” at step S1402), the processing proceeds to step S1403.

Incidentally, even if the port name is changed, the device identification name is not transmitted and registered in the printer, but it is reflected only in the port name of the PC 3-1.

At step S1403, the ports for the printers selected in the screen 17-1 are created in turn in the system of the PC 3-1.

Finally at step S1404, the processing checks whether the ports of all the printers selected in the screen 17-1 have been created. When there remains any port not created (“NO” at step S1404), the processing returns to step S1403. When the port creation is completed for all of the selected printers (“YES” at step S1404), the port creation processing is completed.

At the time of the network installation including the procedure such as sequential setups of the network printers and a plurality of PCs, only by changing the port name at the time of the network installation into the first PC, the same string of characters as the port name of the PC or the string of characters without affix is registered in the network printer as the identification name, and therefore, there is no need to be aware of the fact that the device identification name is attached to the network printer.

When the ports of a plurality of network printers are created in a plurality of PCs, it is possible to take over and use a unified port name without inputting the same port name each time.

Further, since the device identification name is registered at the time of the network installation into the first PC, the network printer already set up can be easily identified by a PC scheduled for the network installation subsequent to the first PC.

Further, the device identification name can be registered, managed, and referred to for each interface in order to determine whether the port created for the PC is a port for performing communications with the wireless LAN interface of the network printer or a port for performing communications with the wired LAN interface of the network printer. Accordingly, it is possible to facilitate the association of the port name with the interface of the network printer.

Further, in a PC scheduled for the network installation subsequent to the first PC, when a plurality of network printers already set up are detected, time required for installation can be saved by creating the ports collectively for the network printers selected by the user while using the device identification name for identification. With respect to a peripheral device, although a printer (an image output device) has been described as an example, it can be an image input device such as a scanner. In this case, the associated port is a port corresponding to an input unit.

As described above, a description has been made on the computer 1, which performs the setup of the port as the output destination or the input destination and corresponds to the network printer A as an example of the information processing device. The port managing unit 2-3 acquires identification information on the port from the network printer A. The port managing unit 2-3 determines whether the identification information on the port is already set up in the network printer A. When the management portion 2-3 determines that the identification information on the port is not yet set up in the network printer A, the identification information on the port corresponding to the network printer A is set up for the network printer A, and further, the identification information on the port is set up by the port managing unit 2-3 in the information processing device as the name of the port. In addition, the port managing unit 2-3 acquires identification information on ports from a plurality of network printers A. The managing unit 2-3 sets up the acquired identification information as names of the ports.

When the port managing unit 2-3 determines that the identification information on the port is already set up, the port managing unit 2-3 does not set up the identification information.

When the port managing unit 2-3 determines that the identification information on the port is already set up, the computer 1 causes the display unit 2-2 to display a warning screen for the user.

Further, the port managing unit 2-3, when the setup instruction is issued after the display of the warning screen, sets up the identification information on the port in the network printer A.

The port managing unit 2-3 acquires identification information on ports from a plurality of network printers. Further, using the acquired identification information on a plurality of ports, the port managing unit 2-3 performs the setups of a plurality of port names for a plurality of network printers A. The identification information on a plurality of ports acquired by the port managing unit 2-3 can be displayed in a list on the display unit 2-2 (a CRT, a liquid crystal display, and the like). A device corresponding to the identification information on the port displayed in a list can be selected by the port managing unit 2-3 according to the input from the user, and the identification information on the port corresponding to the selected device can be set up as a name of the port by the port managing unit 2-3.

Further, when a device driver of the network printer A is installed on the computer 1, the port managing unit 2-3 sets up port identification information on a port, and the communication control unit 2-5 transmits the identification information set up by the port managing unit 2-3 to the network printer A.

Further, the network printer A communicating with the computer A includes a plurality of communication control units 2-9. The network printer A has the storage area 2-8 storing a plurality of corresponding identifiers for each of these communication control units, and transmits a plurality of identifies stored in the storage area 2-8 to the computer 1 using the communication control units 2-9.

When the port configuration allowing the printer to be usable for a plurality of computers is set up in the foregoing embodiment, it is possible to reduce a complicated operation of repeating a change of the port each time.

The processing shown in each figure in the present embodiment is executed by each of the computers 1, 2, and 3 and the network printer A according to a program installed from the outside. In that case, even when a group of information including the program is supplied to the host computer by a recording medium such as a CD-ROM, a flash memory, a flexible disk, and the like or from the recording medium from the outside through the network, the present invention is applicable.

As described above, a recording medium storing program code of software realizing the functions of the foregoing embodiment can be supplied to a system or a device or the program code can be downloaded from an external server (not shown). The present invention can be achieved also even by reading and executing the program code stored in the recording medium by a computer (CPU or MPU) of the system or the device.

In this case, the program code itself read from the recording medium realizes the functions of the present embodiment, and the recording medium storing the program code configures the present invention. As the recording medium supplying the program code, for example, a flexible disk, a hard disk, an optical disk, a magnetic optical disk, a DVD, a CD-ROM, a magnetic tape, a nonvolatile memory card, a ROM, an EEPROM, and the like can be used.

Further, the program code read by the computer can be executed to implement the functions of the foregoing embodiment is realized. In addition, based on the instructions of the program code, an OS (operating system) working on the computer can execute a part or the whole of the actual processing to implement the functions of the foregoing embodiment. Furthermore, the program code read from the recording medium can be written in a memory provided in a function expansion board inserted into the computer or a function expansion unit connected to the computer, and after that, based on the instructions of that program, the CPU provided in the function expansion board or the function expansion unit can execute a part or the whole of the actual processing to implement the functions of the foregoing embodiment.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-234619 filed Aug. 12, 2005, which is hereby incorporated by reference herein in its entirety.

What is claimed is:

1. An information processing device configured to set up a port as one of an output destination and an input destination corresponding to a peripheral device, the information processing device comprising:
a acquiring unit configured to acquire identification information on the port from the peripheral device;
a determining unit configured to determine whether identification information on the port is already set up in the peripheral device; and
a setup unit configured to, when the determining unit determines that identification information on the port is not yet set up in the peripheral device, set up, in the peripheral device, identification information on the port corresponding to the peripheral device and setup, in the information processing device, the identification information on the port as a name of the port.

2. The information processing device according to claim 1, wherein the acquiring unit acquires identification information on ports from a plurality of peripheral devices, and
wherein the setup unit sets up the acquired identification information as names of the ports.

3. The information processing device according to claim 1, wherein, when the determining unit determines that the identification information on the port is already set up, the setup unit does not set up the identification information.

4. The information processing device according to claim 1, further comprising a displaying unit configured to display a warning screen for a user when the determining unit determines that the identification information on the port is already set up,
wherein the setup unit sets up, in the peripheral device, the identification information on the port when a setup instruction is issued from the user after the warning screen is displayed.

5. The information processing device according to claim 1, wherein the acquiring unit acquires identification information on ports from a plurality of peripheral devices, and
wherein the setup unit sets up, in the plurality of peripheral devices, a plurality of port names, respectively, using the identification information on the ports acquired by the acquiring unit.

6. The information processing device according to claim 5, further comprising a displaying unit configured to display in a list the identification information on the ports acquired by the acquiring unit.

7. The information processing device according to claim 6, further comprising a selecting unit configured to select a device corresponding to the identification information on the ports displayed in a list by the displaying unit,
wherein the setup unit sets up identification information on a port corresponding to the device selected by the selecting unit as a name of the port.

8. An information processing device, comprising:
a setup unit configured to set up identification information on a port when a device driver for a peripheral device is installed; and
a transmitting unit configured to transmit the identification information on the port set up by the setup unit to the peripheral device.

9. A peripheral device configured to be in communication with an information processing device, the peripheral device comprising:
a plurality of interface units;
a storing unit configured to store a plurality of identifiers corresponding to the plurality of interface units, respectively; and
a transmitting unit configured to transmit the plurality of identifiers stored in the storing unit to the information processing device.

10. An information processing control method for setting up a port as one of an output destination and an input destination corresponding to a peripheral device, the method comprising:
acquiring identification information on the port from the peripheral device;
determining whether identification information on the port is already set up in the peripheral device; and
if identification information on the port is not yet set up in the peripheral device, setting up, in the peripheral device, identification information on the port corresponding to the peripheral device and setting up, in an information processing device, the identification information on the port as a name of the port.

11. The information processing control method according to claim 10, wherein the acquiring includes acquiring identification information on ports from a plurality of peripheral devices, and
wherein the setting up includes setting up the acquired identification information as names of the ports.

12. The information processing control method according to claim 10, wherein, if the identification information on the port is already set up, the identification information is not set up.

13. The information processing control method according to claim 10, further comprising displaying a warning screen for a user if the identification information on the port is already set up,
wherein the setting up includes setting up, in the peripheral device, the identification information on the port when a setup instruction is issued from the user after the warning screen is displayed.

14. The information processing control method according to claim 10, wherein the acquiring includes acquiring identification information on ports from a plurality of peripheral devices, and
wherein the setting up includes setting up, in the plurality of peripheral devices, a plurality of port names, respectively, using the identification information on the ports acquired in the acquiring step.

15. The information processing control method according to claim 14, further comprising displaying in a list the acquired identification information on the ports.

16. The information processing control method according to claim 15, further comprising selecting a device corresponding to the identification information on the ports displayed in a list,
wherein the setting up includes setting up identification information on a port corresponding to the device selected as a name of the port.

17. An information processing control method, comprising:
setting up identification information on a port when a device driver for a peripheral device is installed; and
transmitting the identification information on the port set up in the setup step to the peripheral device.

18. A method for controlling a peripheral device configured to be in communication with an information processing device, the method comprising:
controlling a plurality of interfaces;
storing a plurality of identifiers corresponding to the plurality of interfaces; and
transmitting the plurality of identifiers stored to the information processing device.

19. A machine-readable medium having stored thereon instructions which, when executed by a computer, causes the computer to execute a method for setting up a port as one of an output destination and an input destination corresponding to a peripheral device, the method comprising:
acquiring identification information on the port from the peripheral device;
determining whether identification information on the port is already set up in the peripheral device; and
when it is determined that identification information on the port is not yet set up in the peripheral device, setting up, in the peripheral device, identification information on the port corresponding to the peripheral device and setting up, in an information processing device, the identification information on the port as a name of the port.

20. A machine-readable medium having stored thereon instructions which, when executed by a peripheral device, causes the peripheral device to execute a method for controlling the peripheral device, the peripheral device being configured to be in communication with an information processing device, the method comprising:
controlling a plurality of interfaces;
storing a plurality of identifiers corresponding to the plurality of controlled interfaces, respectively; and
transmitting the plurality of stored identifiers to the information processing device.

21. A peripheral device configured to communicate with a plurality of information processing apparatus, the peripheral device comprising:
obtaining unit to obtain identification information indicating a port name from one of the information processing apparatus; and
storage unit to store the obtained identification information; and
transmitting unit to transmit the stored identification information to the plurality of information processing apparatus.

22. A method for controlling a peripheral device configured to communicate with a plurality of information processing apparatus, the method comprising:
obtaining identification information indicating a port name from one of the information processing apparatus; and
storing the obtained identification information; and
transmitting the stored identification information to the plurality of information processing apparatus.
